(19) United States
(12) Patent Application Publication
(10) Pub. No.: US 2025/0142689 A1
(43) Pub. Date: May 1, 2025

(54) HEATING COOKER

(71) Applicant: SHARP KABUSHIKI KAISHA, Sakai City (JP)

(72) Inventors: SHINJI ASAMI, Sakai City (JP); MASAYUKI IWAMOTO, Sakai City (JP)

(21) Appl. No.: 18/913,044

(22) Filed: Oct. 11, 2024

(30) Foreign Application Priority Data
Oct. 31, 2023 (JP) 2023-186341

(51) Int. Cl. H05B 6/64; H05B 3/14; H05B 3/44

(52) U.S. Cl. CPC H05B 6/6482; H05B 3/145; H05B 3/44

(57) ABSTRACT

A heating cooker includes: a heating compartment; an infrared heater configured to emit infrared rays directed from an outside to an inside of the heating compartment; a microwave generator configured to emit microwaves directed from the outside to the inside of the heating compartment; a first plate-shaped member positioned between the infrared heater and the heating compartment and have a plurality of through-holes; and a second plate-shaped member positioned apart from the first plate-shaped member between the first plate-shaped member and the infrared heater and have a plurality of through-holes.

### BACKGROUND OF THE INVENTION

### 1. Technical Field

The present disclosure relates to a heating cooker.

The present application claims priority to Japanese Patent Application No. 2023-186341, filed on Oct. 31, 2023, the contents of which are incorporated herein by reference in its entirety.

### 2. Description of the Related Art

In JP 2008-215778 A, a heating cooker heats a heating-target object in a heating compartment with high-frequency waves generated by a high-frequency oscillator or infrared rays generated by an infrared heater. Some infrared heaters are susceptible to a high-frequency wave. Therefore, in JP 2008-215778 A, the infrared heater is shielded with a reflection plate from the heating compartment at the time of heating with the high-frequency wave.

### SUMMARY OF THE INVENTION

In some heating cookers, a plate-shaped member made of metal and subjected to drilling may be fixed between the infrared heater and the heating compartment. This type of plate-shaped member is required to have an ability to shield high-frequency waves during high-frequency heating and an ability to transmit infrared rays during infrared heating.

An object of the present disclosure is to provide a heating cooker having high-frequency wave shielding performance and infrared ray transmission performance even in a case where an infrared heater susceptible to a high-frequency wave is used.

According to one aspect of the present disclosure, a heating cooker includes a heating compartment, an infrared heater, a microwave generator, a first plate-shaped member, and a second plate-shaped member. The infrared heater emits infrared rays directed from an outside to an inside of the heating compartment. The microwave generator emits a microwave directed from the outside to the inside of the heating compartment. The first plate-shaped member is positioned between the infrared heater and the heating compartment and has a plurality of through-holes. The second plate-shaped member is positioned apart from the first plate-shaped member between the first plate-shaped member and the infrared heater and has a plurality of through-holes.

According to the heating cooker of the present disclosure, it is possible to provide a heating cooker having high-frequency wave shielding performance and infrared ray transmission performance even in a case where an infrared heater susceptible to a high-frequency wave is used.

### BRIEF DESCRIPTION OF THE DRAWINGS

FIG. 1 is a perspective view illustrating a heating cooker according to an embodiment of the present disclosure;

FIG. 2 is a perspective view illustrating the heating cooker in a state where a housing is removed according to the embodiment;

FIG. 3 is a perspective view illustrating the heating cooker in a state where the housing is removed according to the embodiment;

FIG. 4 is a perspective view illustrating a door according to the embodiment;

FIG. 5 is a view illustrating a schematic cross section of the heating cooker according to the embodiment;

FIG. 6 is a view illustrating a schematic cross section of an air blower according to the embodiment;

FIG. 7 is a perspective view illustrating the heating cooker in a state where the housing is removed according to the embodiment;

FIG. 8 is a perspective view illustrating the heating cooker in a state where the housing is removed according to the embodiment;

FIG. 9 is a block diagram illustrating a configuration of the heating cooker according to the embodiment;

FIG. 10 is an enlarged view of a cross section of a first heater and a shielding/transmitting portion illustrated in FIG. 5;

FIG. 11 is a perspective view of the shielding/transmitting portion illustrated in FIG. 10 when viewed diagonally from the upper right front;

FIG. 12 is a view of the shielding/transmitting portion illustrated in FIG. 10 when viewed from below; and

FIG. 13 is a graph illustrating wavelength characteristics of a first heater unit with a metal film and a first heater unit without a metal film.

### DETAILED DESCRIPTION

Hereinafter, with reference to the drawings, an embodiment of a heating cooker according to the present disclosure will be described. Note that, in the drawings, the same or corresponding portions are denoted by the same reference numerals, and descriptions thereof will not be repeated.

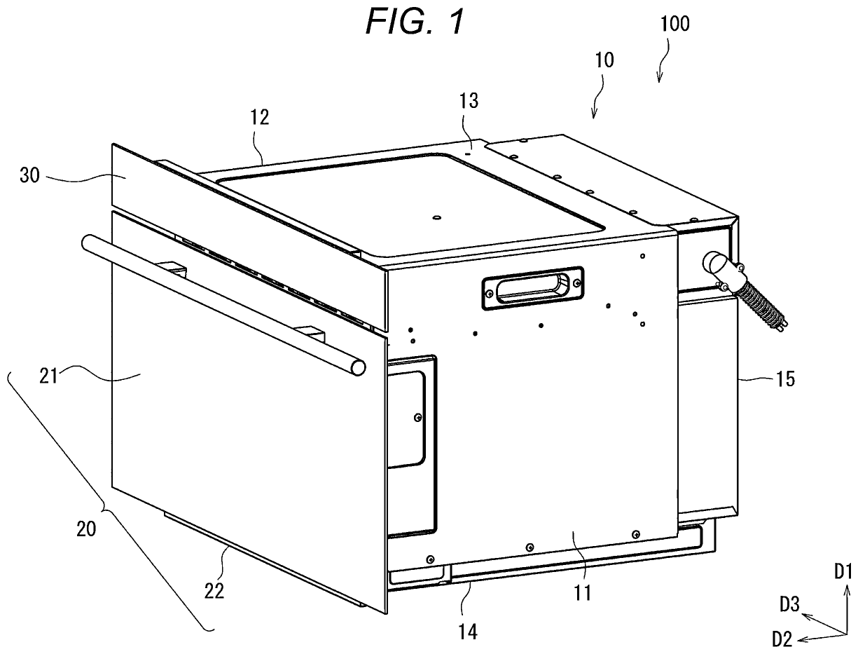

With reference to FIG. 1, a heating cooker 100 according to the embodiment will be described. FIG. 1 is a perspective view illustrating the heating cooker 100. In addition, FIG. 1 illustrates the external appearance of the heating cooker 100 when viewed diagonally from the upper right front. As illustrated in FIG. 1, the heating cooker 100 heats and cooks a heating-target object. The heating-target object is, for example, a food item. The heating cooker 100 includes a housing 10, a door 20, and an operation panel 30.

The operation panel 30 is a substantially rectangular plate-shaped member. The operation panel 30 receives an operation from a user. The operation includes, for example, a cooking method for heating and cooking a heating-target object. Specifically, the operation panel 30 includes a display unit. The display unit displays various items of information. Specifically, the display unit includes a liquid crystal panel.

In the embodiment, a side of the heating cooker 100 on which the operation panel 30 is disposed is defined as a front side of the heating cooker 100, and a side (back surface side) opposite to the front side is defined as a rear side of the heating cooker 100. In addition, when the heating cooker 100 is viewed from the front side, a right side is defined as a right side of the heating cooker 100, and a side opposite to the right side is defined as a left side of the heating cooker 100. In addition, in a direction orthogonal to a front-rear direction and a left-right direction of the heating cooker 100, a side on which the operation panel 30 is disposed is defined as an upper side of the heating cooker 100, and a side (bottom side) opposite to the upper side is defined as a lower side of the heating cooker 100. Note that, these directions and sides are not intended to limit directions and sides when the heating cooker 100 of the present disclosure is used. In the embodiment, a first direction D1 is an upward direction. A second direction D2 is a forward direction. A third direction D3 is a left direction.

The housing 10 is a box-shaped member. Specifically, the housing 10 has a right outer wall 11, a left outer wall 12, an upper outer wall 13, a lower outer wall 14, and a rear outer wall 15. The rear outer wall 15 intersects the second direction D2. The right outer wall 11 and the left outer wall 12 face each other in the third direction D3. The upper outer wall 13 and the lower outer wall 14 face each other in the first direction D1.

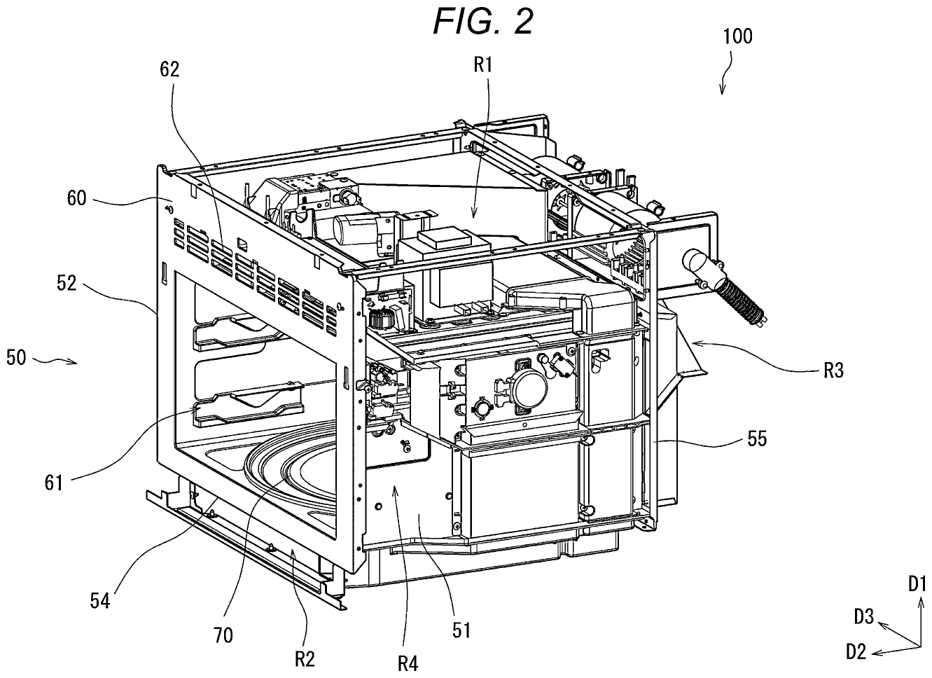

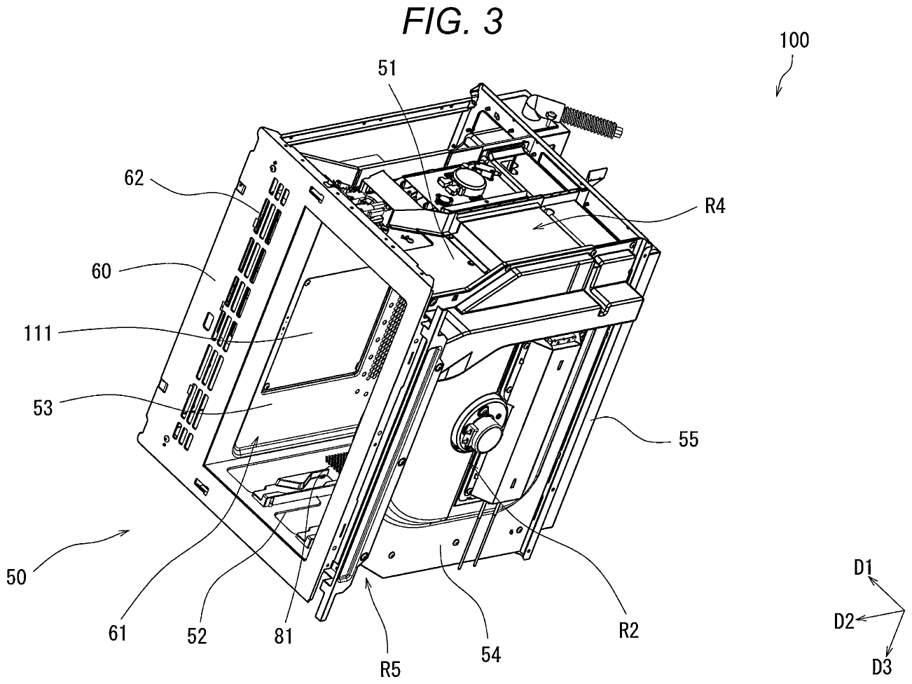

Continuing, a heating cooking compartment 50 will be described with reference to FIGS. 1 to 3. FIGS. 2 and 3 are perspective views illustrating the heating cooker 100 from which the housing 10 has been removed. FIG. 2 illustrates the external appearance of the heating cooker 100 when viewed diagonally from the upper right front. FIG. 3 illustrates the external appearance of the heating cooker 100 when viewed diagonally from the lower right front. As illustrated in FIGS. 2 and 3, the heating cooker 100 further includes the heating cooking compartment 50, a front wall 60, and a placement portion 70. The heating cooking compartment 50 is an example of a “heating compartment” of the present disclosure.

The heating cooking compartment 50 is accommodated in the housing 10. The heating cooking compartment 50 allows a heating-target object to be accommodated therein. The heating cooking compartment 50 has, for example, a substantially rectangular parallelepiped shape. Specifically, the heating cooking compartment 50 has a right wall 51, a left wall 52, an upper wall 53, a lower wall 54, and a rear wall 55. The rear wall 55 intersects the second direction D2. The right wall 51 and the left wall 52 face each other in the third direction D3. The upper wall 53 and the lower wall 54 face each other in the first direction D1. Examples of a material of each of the right wall 51, the left wall 52, the upper wall 53, the lower wall 54, and the rear wall 55 are metals.

The placement portion 70 is a dish-shaped member. The placement portion 70 is accommodated in the heating cooking compartment 50. The placement portion 70 is configured to allow the heating-target object to be placed. To be specific, the placement portion 70 is rotatable about a rotation axis in the first direction D1.

The heating cooker 100 further includes a first space R1, a second space R2, a third space R3, a fourth space R4, and a fifth space R5. The first space R1 is disposed between the upper outer wall 13 and the upper wall 53. The second space R2 is disposed between the lower outer wall 14 and the lower wall 54. The third space R3 is disposed between the rear outer wall 15 and the rear wall 55. The fourth space R4 is disposed between the right outer wall 11 and the right wall 51. The fifth space R5 is disposed between the left outer wall 12 and the left wall 52.

The front wall 60 is a plate-shaped member including an opening 61 having a substantially rectangular shape in a front view. The front wall 60 faces the rear wall 55. In addition, the front wall 60 faces the rear outer wall 15. The front wall 60 further includes a plurality of through-hole portions 62. The opening 61 allows an inside and an outside of the heating cooking compartment 50 to communicate with each other.

The plurality of through-hole portions 62 are positioned above the opening 61. Each of the plurality of through-hole portions 62 allows an inside and an outside of the first space R1 to communicate with each other. The plurality of through-hole portions 62 form eight columns. In each of the eight columns of the through-hole portions 62, three through-holes are arranged in a column in an up-down direction.

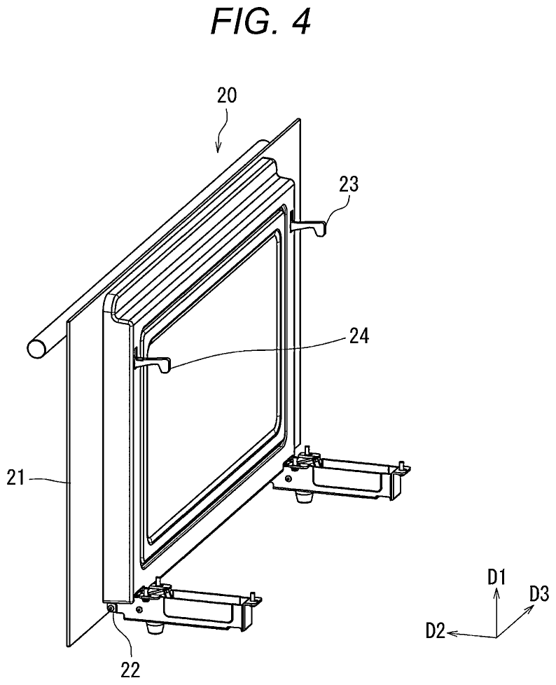

Continuing, the door 20 will be described with reference to FIGS. 1 to 4. FIG. 4 is a perspective view illustrating the door 20. As illustrated in FIGS. 1 to 4, the door 20 includes a substantially rectangular plate-shaped member 21 and a rotary shaft unit 22.

The rotary shaft unit 22 is positioned in the vicinity of a lower end of the plate-shaped member 21. The plate-shaped member 21 opens and closes the opening 61. Specifically, the plate-shaped member 21 rotates about a rotation axis in the third direction D3. The plate-shaped member 21 opens the opening 61 in a state of being orthogonal to the first direction D1. On the other hand, the plate-shaped member 21 closes the opening 61 in a state of being orthogonal to the second direction D2.

To be specific, the door 20 includes a first connection member 23 and a second connection member 24. Both the first connection member 23 and the second connection member 24 connect the heating cooking compartment 50 and the door 20 when the door 20 is positioned at a closed position.

The first connection member 23 and the second connection member 24 are attached to the plate-shaped member 21. The first connection member 23 and the second connection member 24 face each other in the left-right direction. The first connection member 23 is attached to a left edge portion of a rear surface of the plate-shaped member 21. The second connection member 24 is attached to a right edge portion of the rear surface of the plate-shaped member 21.

For example, each of the first connection member 23 and the second connection member 24 has a hook member. The hook member is a plate-shaped member having a longitudinal direction thereof in the front-rear direction. The hook member includes a claw portion and a rotation pin portion. The rotation pin portion is positioned at one end portion of the hook member. The rotation pin portion rotates about a rotation axis extending in the third direction D3. On the other hand, the claw portion has a projecting portion projecting downward. The claw portion is positioned at the other end portion of the hook member. As a result, the claw portion is rotatable around the rotation pin portion.

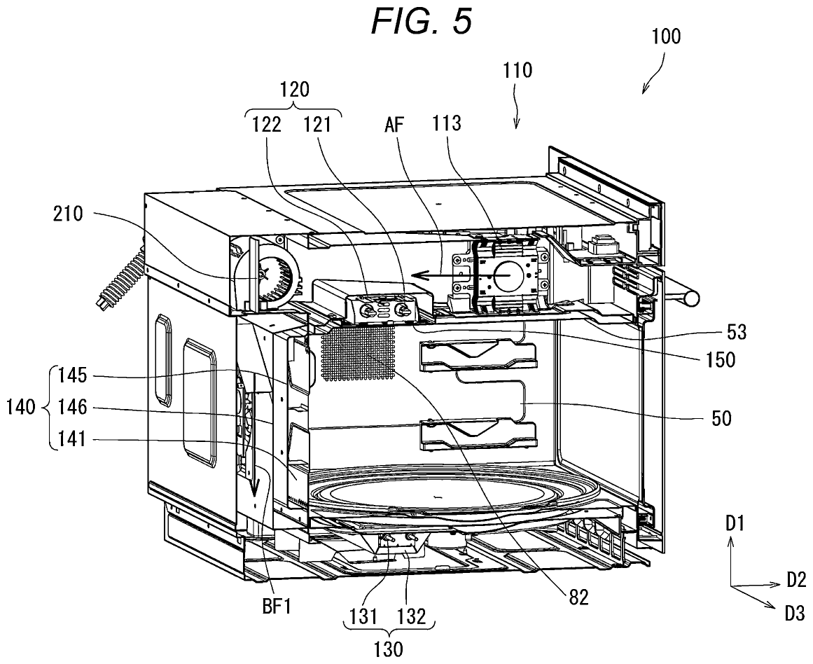

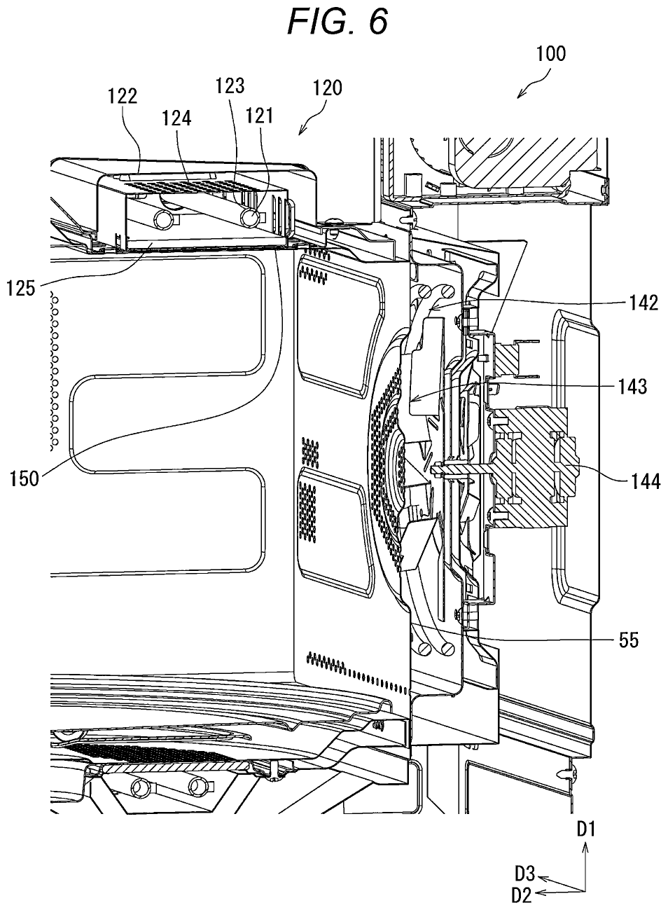

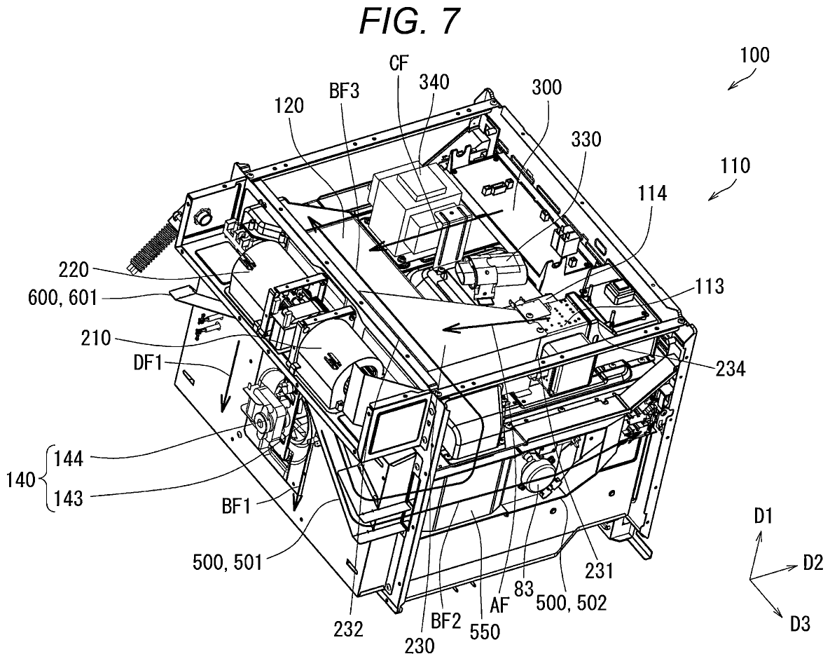

Next, the heating cooker 100 will be further described with reference to FIGS. 5 to 7. FIG. 5 is a view illustrating a schematic cross section of the heating cooker 100. To be specific, FIG. 5 is a cross-sectional view illustrating the heating cooker 100 cut along a plane orthogonal to the third direction D3. In addition, FIG. 6 is a view illustrating a schematic cross section of an air blower 140 according to the embodiment. Further, FIG. 7 is a perspective view illustrating the heating cooker 100. To be specific, FIG. 7 illustrates the external appearance of the heating cooker 100 when viewed diagonally from the upper left rear.

As illustrated in FIGS. 5 to 7, the heating cooker 100 includes a microwave supply unit 110, a first heater unit 120, a second heater unit 130, and the air blower 140. Each of the microwave supply unit 110, the first heater unit 120, the second heater unit 130, and the air blower 140 heats the heating-target object.

First, the microwave supply unit 110 will be described. The microwave supply unit 110 supplies microwaves into the heating cooking compartment 50.

The microwave supply unit 110 is disposed on the upper wall 53 of the heating cooking compartment 50. Specifically, the microwave supply unit 110 is positioned above the heating cooking compartment 50 with the upper wall 53 interposed therebetween. The microwave supply unit 110 includes a partition member 111 (see FIG. 3), a radiation chamber, a magnetron 113, and a waveguide 114.

The magnetron 113 is disposed closer to the front wall 60 than the first heater unit 120. The magnetron 113 generates microwaves. The waveguide 114 propagates microwaves generated by the magnetron to the radiation chamber.

The partition member 111 is disposed between the radiation chamber and the upper wall 53 of the heating cooking compartment 50. Examples of a material of the partition member 111 are non-metals, and include a ceramic or mica. As a result, since the material of the partition member 111 includes a ceramic or mica, the partition member 111 transmits microwaves. On the other hand, materials of the radiation chamber and the waveguide 114 include metals.

Next, the first heater unit 120 will be described. The first heater unit 120 is disposed on the upper wall 53 of the heating cooking compartment 50. The first heater unit 120 is, for example, a carbon heater. Since the carbon heater increases the temperature quickly, the heating-target object can be cooked in a short time. A halogen heater also has a faster temperature rise time, but the carbon heater has a larger amount of far-infrared radiation than the halogen heater does, so that the heating-target object can be cooked in a shorter time. Specifically, the first heater unit 120 includes a first heater 121, a first tube 123, a heat reflection plate 124, a thermal shield plate 122, and a glass plate 125.

To be specific, the first heater 121 includes a resistance heating element inside a glass tube, and generates heat by energizing the resistance heating element. In the embodiment, the resistance heating element is carbon.

The first tube 123 is made of glass. The first tube 123 accommodates the first heater 121. The first tube 123 extends in the third direction D3.

The heat reflection plate 124 covers an upper side of the first tube 123. The heat reflection plate 124 covers an upper side, a front side, and a rear side of the first heater 121. The heat reflection plate 124 reflects heat toward the heating cooking compartment 50.

The thermal shield plate 122 covers an upper side of the heat reflection plate 124. An air layer 126 is provided between the heat reflection plate 124 and the thermal shield plate 122. The thermal shield plate 122 covers an upper side, a front side, and a rear side of the heat reflection plate 124.

The glass plate 125 is a substantially rectangular plate-shaped member. The glass plate 125 is disposed between a lower side of the first tube 123 and the heating cooking compartment 50. In other words, the glass plate 125 separates the first tube 123 from the heating cooking compartment 50. As a result, the glass plate 125 transmits heat rays from the first heater 121 to the heating cooking compartment 50. On the other hand, the glass plate 125 prevents moisture and salt from moving from the heating cooking compartment 50 to the first tube 123. Accordingly, a devitrification phenomenon of the first tube 123 can be prevented.

Next, the second heater unit 130 will be described. The second heater unit 130 is disposed on the lower wall 54 of the heating cooking compartment 50. The second heater unit 130 includes a second heater 131 and a second heater case 132. The second heater 131 is, for example, a glass tube heater, and the resistance heating element is a nichrome wire. The second heater 131 in the state of power application generates heat. An output of the second heater 131 is lower than an output of the first heater 121. The second heater case 132 covers a lower side, a front side, and a rear side of the second heater 131. The second heater case 132 is made of a material including metal. The second heater 131 in the state of power application generates heat.

Next, the air blower 140 will be described. The air blower 140 is configured to supply hot air into the heating cooking compartment 50. The air blower 140 is disposed on the rear wall 55. Specifically, the air blower 140 is positioned behind the heating cooking compartment 50 with the rear wall 55 interposed therebetween.

Specifically, the air blower 140 includes an air blowing chamber 141, a third heater 142, a centrifugal fan 143, a drive unit 144, a partition member 145, and a heat shield plate 146. The air blowing chamber 141 is, for example, a box-shaped member made of metal. The centrifugal fan 143 has a plurality of blades.

The third heater 142 and the centrifugal fan 143 are accommodated in the air blowing chamber 141. The third heater 142 heats air inside the air blowing chamber 141 to generate hot air. Specifically, the third heater 142 has an annular shape when viewed from the front side toward the rear side. The third heater 142 is disposed along an outer circumference of the centrifugal fan 143.

The rear wall 55 has a suction hole portion and a blow-out hole portion. To be specific, the suction hole portion is, for example, a group of a plurality of punched holes. Similarly, the blow-out hole portion is also, for example, a group of a plurality of punched holes. A punched hole has, for example, a circular shape. A diameter of a punched hole of each of the suction hole portion and the blow-out hole portion is, for example, 3.4 mm in order to prevent microwaves from leaking.

The partition member 145 is, for example, a plate-shaped member made of metal. The partition member 145 has, for example, an oblong shape when viewed from the front side toward the rear side. The partition member 145 is disposed on substantially the entire surface of the rear wall 55. Specifically, the partition member 145 is positioned on the outward side from the rear wall 55.

The heat shield plate 146 is, for example, a plate-shaped member made of metal. The heat shield plate 146 is, for example, a plate-shaped member having a quadrangular ring shape when viewed from the front side toward the rear side. The heat shield plate 146 is positioned on the outward side from the partition member 145.

The drive unit 144 is positioned an outward side from the air blowing chamber 141. Specifically, the drive unit 144 is positioned on an outward side from the heat shield plate 146, and a shaft portion of the drive unit 144 penetrates the partition member 145 and the heat shield plate 146 and is connected to the centrifugal fan 143. The drive unit 144 drives the centrifugal fan 143. The drive unit 144 includes, for example, a motor.

The air blower 140 draws in hot air in the heating cooking compartment 50 through the suction hole portion, and blows hot air into the heating cooking compartment 50 through the blow-out hole portion. To be more specific, the air blower 140 draws in hot air from a central portion inside the heating cooking compartment 50 and blows the hot air to a peripheral border portion inside the heating cooking compartment 50. As a result, the entire inside of the heating cooking compartment 50 can be heated by driving the air blower 140.

As illustrated in FIGS. 3 and 5 to 8 again, the heating cooking compartment 50 further includes the intake hole portion 81, the exhaust hole portion 82, the intake damper unit 83, and the exhaust damper unit 84.

The intake hole portion 81 allows the inside and the outside of the heating cooking compartment 50 to communicate with each other. Specifically, the intake hole portion 81 is disposed on the left wall 52. The intake hole portion 81 has, for example, a quadrangular shape. Specifically, the intake hole portion 81 includes, for example, a plurality of punched holes. A punched hole has, for example, a circular shape. A diameter of a punched hole of the intake hole portion 81 is, for example, 3.4 mm in order to prevent microwaves from leaking.

The intake damper unit 83 opens and closes the intake hole portion 81. The intake damper unit 83 is attached to an outer side of the left wall 52. For example, in a case where the intake damper unit 83 opens the intake hole portion 81, the inside and the outside of the heating cooking compartment 50 communicate with each other. As a result, air is guided to the intake hole portion 81. On the other hand, in a case where the intake damper unit 83 closes the intake hole portion 81, the inside and the outside of the heating cooking compartment 50 do not communicate with each other. As a result, air is not guided to the intake hole portion 81.

In addition, the exhaust hole portion 82 allows the inside and the outside of the heating cooking compartment 50 to communicate with each other. Specifically, the exhaust hole portion 82 is disposed on the right wall 51. The exhaust hole portion 82 has, for example, a quadrangular shape. Specifically, the exhaust hole portion 82 includes, for example, a plurality of punched holes. A punched hole has, for example, a circular shape. A diameter of a punched hole of the exhaust hole portion 82 is, for example, 3.4 mm in order to prevent microwaves from leaking.

The exhaust damper unit 84 opens and closes the exhaust hole portion 82. The exhaust damper unit 84 is attached to an outer side of the right wall 51. For example, in a case where the exhaust damper unit 84 opens the exhaust hole portion 82, the inside and the outside of the heating cooking compartment 50 communicate with each other. On the other hand, in a case where the exhaust damper unit 84 closes the exhaust hole portion 82, the inside and the outside of the heating cooking compartment 50 do not communicate with each other.

Continuing, a flow of the air will be described in detail. First, the intake damper unit 83 opens the intake hole portion 81, and the exhaust damper unit 84 opens the exhaust hole portion 82. As a result, air is guided to the intake hole portion 81. The air is blown into the heating cooking compartment 50 through the intake hole portion 81. The air blown from the intake hole portion 81 moves into the heating cooking compartment 50 in a direction opposite to the third direction D3. Thereafter, the air is discharged from the exhaust hole portion 82 to the outside of the heating cooking compartment 50.

As illustrated in FIGS. 5 to 7, the heating cooker 100 further includes a first fan 210, a first wind direction plate 500, and a first guide unit 550. For example, the first fan 210 is a Sirocco fan. The first fan 210 is disposed on the upper wall 53 of the heating cooking compartment 50. In addition, the first fan 210 is disposed between the rear wall 55 of the heating cooking compartment 50 and the rear outer wall 15 of the housing 10. Specifically, the first fan 210 is disposed in a region in which the first space R1 and the third space R3 overlap each other.

To be specific, the first fan 210 is positioned at the same height as the plurality of through-hole portions 62 are. The first fan 210 generates an air flow between the upper wall 53 of the heating cooking compartment 50 and the upper outer wall 13 of the housing 10. The first fan 210 takes air outside the heating cooker 100 into the first space R1. In addition, the first fan 210 generates an air flow between the rear wall 55 of the heating cooking compartment 50 and the rear outer wall 15 of the housing 10. The first fan 210 discharges the air in the first space R1 into the third space R3.

The first wind direction plate 500 includes a first skew plate 501, a second skew plate 503, and a horizontal plate 502.

The first skew plate 501 guides a part of the air flow into the first guide unit 550 leading to the intake hole portion 81, and guides the remaining part of the air flow to the outside of the first guide unit 550. Specifically, the first skew plate 501 is disposed on the heat shield plate 146. The first skew plate 501 is provided upright on the heat shield plate 146. The first skew plate 501 extends from below the first fan 210 toward the left wall 52.

The second skew plate 503 guides a part of the air flow into the first guide unit 550 leading to the first heater unit 120, and guides the remaining part of the air flow to the outside of the first guide unit 550. Specifically, the second skew plate 503 is disposed on the heat shield plate 146. The second skew plate 503 is provided upright on the heat shield plate 146. The second skew plate 503 is positioned on the upper side from the first skew plate 501. The second skew plate 503 extends from below the first fan 210 toward the left wall 52.

The first guide unit 550 guides air flows to the first heater unit 120 and the intake hole portion 81. The first guide unit 550 guides the air flows from the first fan 210 toward the first heater unit 120 and the intake hole portion 81. Specifically, the first guide unit 550 is a cylindrical body. The cylindrical body has a suction port and a blow-out port. The cylindrical body is disposed on the left wall 52. The suction port is open in the direction opposite to the second direction D2. The blow-out port is open toward the first heater unit 120 and the intake hole portion 81.

The horizontal plate 502 is disposed on the left wall 52. The horizontal plate 502 is provided upright on the left wall 52. The horizontal plate 502 passes below the intake damper unit 83 from the rear wall 55 and extends toward the front wall 60.

Here, a flow of air generated by driving of the first fan 210 will be described. When driven, the first fan 210 generates an intake air flow AF. The intake air flow AF passes through the plurality of through-hole portions 62 from the outside of the heating cooker 100, circulates in the first space R1 between the microwave supply unit 110 and the upper outer wall 13 in a direction opposite to the second direction D2, and flows toward the first heater unit 120. At this time, the intake air flow AF cools the magnetron 113 of the microwave supply unit 110. The intake air flow AF that has cooled the magnetron 113 circulates in the first space R1 between the first heater unit 120 and the upper outer wall 13 in a direction opposite to the second direction D2 and flows toward the first fan 210. At this time, the intake air flow AF cools the thermal shield plate 122 of the first heater unit 120. In other words, the first fan 210 generates an air flow that circulates through the magnetron 113 and the first heater unit 120 in this order.

In addition, when driven, the first fan 210 generates a blown air flow BF1, a blown air flow BF2, and a blown air flow BF3. The blown air flow BF1 is blown downward. The blown air flow BF1 circulates downward in the third space R3 between the air blower 140 and the rear outer wall 15. At this time, the blown air flow BF1 cools the drive unit 144 of the air blower 140.

The blown air flow BF1 reaching the lower outer wall 14 circulates in the second space R2 between the lower outer wall 14 and the second heater unit 130 in the second direction D2. At this time, the blown air flow BF1 cools the second heater case 132 of the second heater unit 130. In other words, the first fan 210 generates an air flow that circulates through the magnetron 113, the first heater unit 120, and the second heater unit 130 in this order. The blown air flow BF1 that has cooled the second heater unit 130 is discharged to the outside of the heating cooker 100.

In addition, the blown air flow BF2 reaches the first skew plate 501. The blown air flow BF2 reaching the first skew plate 501 is guided to the left wall 52 along the first skew plate 501. A part of the blown air flow BF2 guided to the left wall 52 is guided to the first guide unit 550 leading to the intake hole portion 81. In addition, the remaining part of the blown air flow BF2 is guided to the outside of the first guide unit 550 and circulates in the second direction D2 along the horizontal plate 502.

Further, the blown air flow BF3 reaches the second skew plate 503. The blown air flow BF3 reaching the second skew plate 503 is guided to the left wall 52 along the second skew plate 503. A part of the blown air flow BF3 guided to the left wall 52 circulates in the first guide unit 550. The blown air flow BF3 that has circulated in the first guide unit 550 circulates in the first heater unit 120 in a direction opposite to the third direction D3. At this time, the blown air flow BF3 cools the first heater unit 120. The blown air flow BF3 that has cooled the first heater unit 120 is guided to the right wall 51. In addition, the remaining part of the blown air flow BF2 is guided to the left wall 52 circulates in the second direction D2 along the horizontal plate 502.

As described above with reference to FIGS. 1 to 5, the first fan 210 generates the air flow that circulates through the magnetron 113 and the first heater unit 120 in this order, and thus can efficiently cool the magnetron 113 disposed on the upper wall 53 of the heating cooking compartment 50.

In addition, the first fan 210 generates an air flow between the upper wall 53 of the heating cooking compartment 50 and the upper outer wall 13 of housing 10, and thus can more efficiently cool the magnetron 113 disposed on the upper wall 53 of the heating cooking compartment 50.

Since the first fan 210 is disposed between the rear wall 55 of the heating cooking compartment 50 and the rear outer wall 15 of the housing 10, it is possible to reduce transmission of the driving sound of the first fan 210 to the user. Further, the magnetron 113 and the thermal shield plate 122 are disposed between the first fan 210 and the through-hole portions 62, and thereby it is possible to block a part of the driving sound of the first fan 210, so that it is possible to further reduce transmission of the driving sound of the first fan 210 to the user.

Further, the first fan 210 generates the air flow that circulates through the magnetron 113, the first heater unit 120, and the second heater unit 130 in this order, and thus can efficiently cool the magnetron 113 disposed on the upper wall 53 of the heating cooking compartment 50.

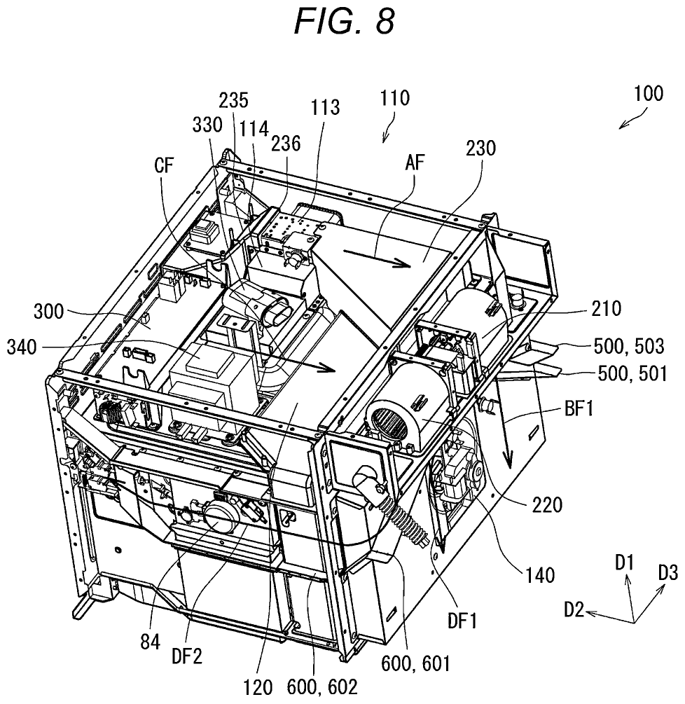

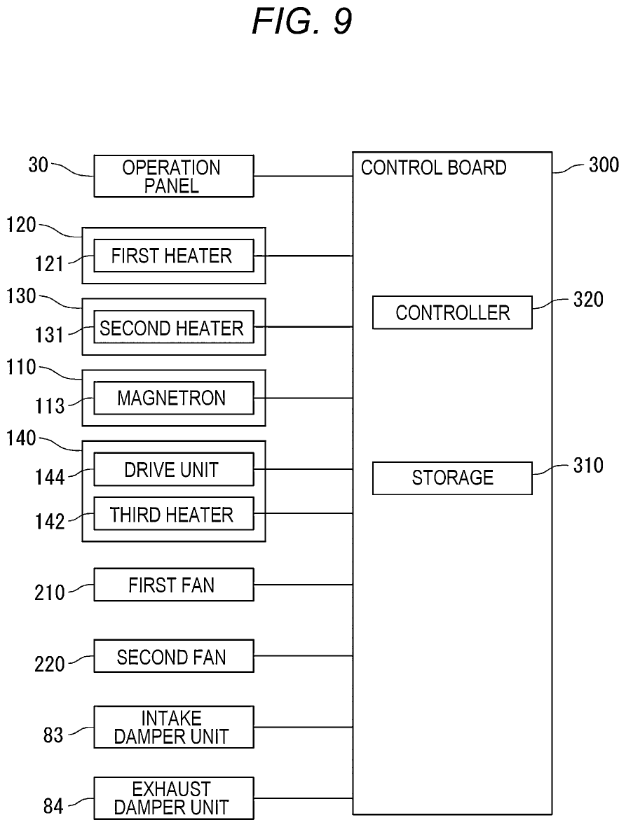

Continuing with reference to FIGS. 7 to 9, a second fan 220 will be described. FIG. 8 is a perspective view illustrating the heating cooker 100. To be specific, FIG. 8 illustrates the external appearance of the heating cooker 100 when viewed diagonally from the upper right rear. FIG. 9 is a block diagram illustrating a configuration of the heating cooker 100. As illustrated in FIGS. 6 to 9, the heating cooker 100 further includes the second fan 220, a second wind direction plate 600, a control board 300, a high-voltage capacitor 330, and a high-voltage transformer 340.

The control board 300 includes a storage 310 and a controller 320. The storage 310 includes a random access memory (RAM) and a read only memory (ROM). The storage 310 stores control programs for controlling an operation of each component of the heating cooker 100.

The controller 320 is a hardware circuit including a processor such as a central processing unit (CPU). The controller 320 executes the control programs stored in the storage 310.

The high-voltage capacitor 330 is disposed between the first fan 210 and the second fan 220 and the through-hole portions 62.

The high-voltage transformer 340 is disposed between the second fan 220 and the through-hole portions 62.

For example, the second fan 220 is a Sirocco fan. The first fan 210 and the second fan 220 are arranged side by side in the left-right direction. The second fan 220 is disposed on the upper wall 53 of the heating cooking compartment 50. In addition, the second fan 220 is disposed between the rear wall 55 of the heating cooking compartment 50 and the rear outer wall 15 of the housing 10. Specifically, the second fan 220 is disposed in the region in which the first space R1 and the third space R3 overlap each other.

To be specific, the second fan 220 is positioned at the same height as the plurality of through-hole portions 62 are. The second fan 220 generates an air flow between the upper wall 53 of the heating cooking compartment 50 and the upper outer wall 13 of the housing 10. The second fan 220 takes air outside the heating cooker 100 into the first space R1. In addition, the second fan 220 generates an air flow between the rear wall 55 of the heating cooking compartment 50 and the rear outer wall 15 of the housing 10. The second fan 220 discharges the air in the first space R1 into the third space R3.

The second wind direction plate 600 guides an air flow to the exhaust damper unit 84. Specifically, the second wind direction plate 600 includes a skew plate 601 and a horizontal plate 602.

The skew plate 601 is disposed on the rear wall 55. The skew plate 601 is provided upright on the heat shield plate 146. The skew plate 601 extends from below the second fan 220 toward the right wall 51.

The horizontal plate 602 is disposed on the right wall 51. The horizontal plate 602 is provided upright on the right wall 51. The horizontal plate 602 passes below the exhaust damper unit 84 from the rear wall 55 and extends toward the front wall 60.

Here, a flow of air generated by driving of the second fan 220 will be described. When driven, the second fan 220 generates an intake air flow CF. The intake air flow CF passes through the plurality of through-hole portions 62 from the outside of the heating cooker 100, circulates in the first space R1 between the control board 300 and the upper outer wall 13 in the direction opposite to the second direction D2, and flows toward the first heater unit 120. At this time, the intake air flow CF cools the control board 300. The intake air flow CF that has cooled the control board 300 circulates in the first space R1 between the first heater unit 120 and the upper outer wall 13 in the direction opposite to the second direction D2 and flows toward the second fan 220. At this time, the intake air flow CF cools the thermal shield plate 122 of the first heater unit 120. In other words, the second fan 220 generates an air flow that circulates through the control board 300 and the first heater unit 120 in this order.

In addition, when driven, the second fan 220 generates a blown air flow DF1 and a blown air flow DF2. The blown air flow DF1 is blown downward. The blown air flow DF1 circulates downward in the third space R3 between the air blower 140 and the rear outer wall 15. At this time, the blown air flow DF1 cools the drive unit 144 of the air blower 140.

The blown air flow DF1 reaching the lower outer wall 14 circulates in the second space R2 between the lower outer wall 14 and the second heater unit 130 in the second direction D2. At this time, the blown air flow DF1 cools the second heater case 132 of the second heater unit 130. In other words, the second fan 220 generates an air flow that circulates through the control board 300, the first heater unit 120, and the second heater unit 130 in this order. The blown air flow DF1 that has cooled the second heater unit 130 is discharged to the outside of the heating cooker 100.

In addition, the blown air flow DF2 reaches the skew plate 601. The blown air flow DF2 reaching the skew plate 601 is guided to the right wall 51 along the skew plate 601. The blown air flow DF2 guided to the right wall 51 circulates in the second direction D2 along the horizontal plate 602. At this time, the blown air flow DF2 cools the exhaust damper unit 84. The blown air flow DF2 that has cooled the exhaust damper unit 84 is discharged to the outside of the heating cooker 100.

As described above with reference to FIGS. 7 to 9, the magnetron 113, the high-voltage capacitor 330, and the control board 300 are disposed between the first fan 210 and the through-hole portions 62, and thereby it is possible to block a part of the driving sound of the first fan 210, so that it is possible to further reduce transmission of the driving sound of the first fan 210 to the user. In addition, the high-voltage transformer 340, the high-voltage capacitor 330, and the control board 300 are disposed between the second fan 220 and the through-hole portions 62, and thereby it is possible to block a part of the driving sound of the second fan 220, so that it is possible to further reduce transmission of the driving sound of the second fan 220 to the user.

As illustrated in FIGS. 7 and 8 again, the heating cooker 100 further includes a front duct member 234 and a rear duct member 230.

The front duct member 234 extends from the front wall 60 toward the magnetron 113. Specifically, the front duct member 234 is a groove-shaped member having a substantially U-shaped cross section and a longitudinal direction in the second direction D2. The front duct member 234 is disposed in the first space R1. The front duct member 234 faces the upper wall 53.

To be specific, the front duct member 234 has a suction port 235 and a blow-out port 236. The suction port 235 is open in the second direction D2. The blow-out port 236 is open in the direction opposite to the second direction D2. The suction port 235 is smaller in size than the blow-out port 236. The blow-out port 236 is positioned in front of the magnetron 113. The blow-out port 236 is close to the magnetron 113.

The rear duct member 230 extends from the magnetron 113 toward the first fan 210.

Specifically, the rear duct member 230 is a groove-shaped member having a substantially U-shaped cross section and a longitudinal direction in the second direction D2. The rear duct member 230 is disposed in the first space R1. The rear duct member 230 faces the upper wall 53.

To be specific, the rear duct member 230 has a suction port 231 and a blow-out port 232. The suction port 231 is open in the second direction D2. The blow-out port 232 is open in the direction opposite to the second direction D2. The suction port 231 is smaller in size than the blow-out port 232. The blow-out port 232 is positioned in front of the first fan 210. The blow-out port 232 is close to the first fan 210.

Here, a flow of air generated by driving of the first fan 210 will be described. When driven, the first fan 210 generates an intake air flow AF. The intake air flow AF passes through the plurality of through-hole portions 62 from the outside of the heating cooker 100, circulates in the front duct member 234 in the direction opposite to second direction D2, and flows into rear duct member 230. At this time, the intake air flow AF cools the magnetron 113 of the microwave supply unit 110. The intake air flow AF that has cooled the magnetron 113 circulates in the rear duct member 230 in the direction opposite to the second direction D2 and flows toward the first fan 210. At this time, the intake air flow AF cools the thermal shield plate 122. In other words, the first fan 210 generates an air flow that circulates through the magnetron 113 and the first heater unit 120 in this order.

As described above with reference to FIGS. 7 and 8, since the heating cooker 100 further includes the front duct member 234 and the rear duct member 230, the magnetron 113 disposed on the upper wall 53 of the heating cooking compartment 50 can be more efficiently cooled. Further, the magnetron 113, the high-voltage capacitor 330, the front duct member 234, and the rear duct member 230 are disposed between the first fan 210 and the through-hole portions 62, and thereby it is possible to block a part of the driving sound of the first fan 210, so that it is possible to further reduce transmission of the driving sound of the first fan 210 to the user.

With reference to FIG. 9 again, a configuration of the heating cooker 100 will be described in detail. In the embodiment, the heating cooker 100 has, as heating cooking modes, a “microwave heating mode”, a “hot air circulation heating mode”, and a “grill heating mode”. The “microwave heating mode” is a mode for heating and cooking a heating-target object mainly by radiating microwaves into the heating cooking compartment 50. The “grill heating mode” means a mode for heating and cooking a heating-target object mainly by causing heat generated from the first heater unit 120 and the second heater unit 130 to radiate to the heating-target object. The “hot air circulation heating mode” is a mode for heating and cooking a heating-target object mainly by circulating hot air throughout the heating cooking compartment 50 to ensure a uniform temperature in the heating cooking compartment 50.

The controller 320 executes control programs stored in the storage 310, thereby controlling driving of the microwave supply unit 110, driving of the air blower 140, driving of the first heater unit 120, driving of the second heater unit 130, driving of the first fan 210, and driving of the second fan 220.

To be specific, the controller 320 controls the operation panel 30, the magnetron 113, the first heater 121, the second heater 131, the third heater 142, the drive unit 144, the first fan 210, the second fan 220, the intake damper unit 83, and the exhaust damper unit 84. For example, in the case where the “microwave heating mode” is selected, the controller 320 drives the magnetron 113, the first fan 210, the second fan 220, the intake damper unit 83, and the exhaust damper unit 84. In addition, in the case where the “grill heating mode” is selected, the controller 320 drives the first heater 121, the second heater 131, the first fan 210, and the second fan 220. Further, in the case where the “hot air circulation heating mode” is selected, the controller 320 drives the drive unit 144, the first fan 210, and the second fan 220, and drives at least one of the first heater 121, the second heater 131, and the third heater 142.

The heating cooker 100 further has a “high-speed cooking mode”. For example, in the case where the “high-speed cooking mode” is selected, the controller 320 drives the magnetron 113, the first fan 210, the second fan 220, the first heater 121, the second heater 131, the drive unit 144, and the third heater 142.

Although the heating cooking mode has been described above, the heating cooking mode is not limited thereto, and the magnetron 113, the first fan 210, the second fan 220, the first heater 121, the second heater 131, the drive unit 144, and the third heater 142 can be freely combined.

As clear from the above, the heating cooker 100 can heat the heating-target object by microwave heating or infrared heating.

In the microwave heating, the microwave supply unit 110 generates microwaves directed from the outside to the inside of the heating cooking compartment 50. The magnetron 113 exemplifies a “microwave generator” according to the present disclosure. The heating-target object is heated by microwaves.

On the other hand, in the infrared heating, the first heater unit 120 emits infrared rays directed from the outside to the inside of the heating cooking compartment 50. The first heater unit 120 is an example of an “infrared heater” of the present disclosure. The heating-target object is heated by infrared rays.

In the embodiment, since the first heater 121 is a carbon heater, the first heater 121 is susceptible to the microwaves from the magnetron 113. As illustrated in FIG. 6, the heating cooker 100 includes a shielding/transmitting portion 150. Since the shielding/transmitting portion 150 can transmit infrared rays while shielding microwaves, heating by microwaves and infrared rays can be performed at the same time.

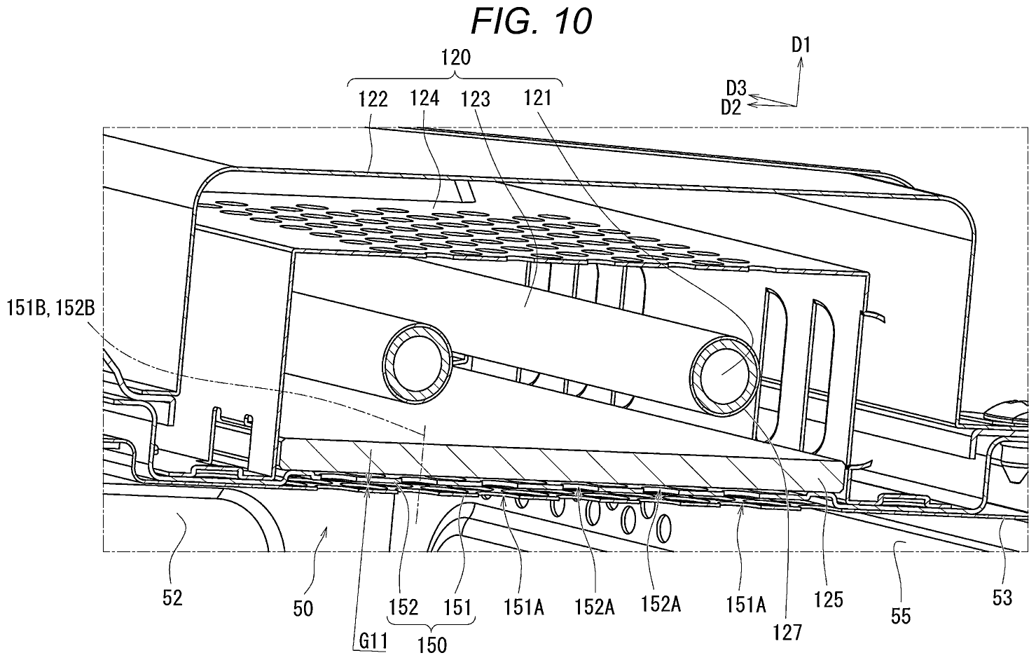

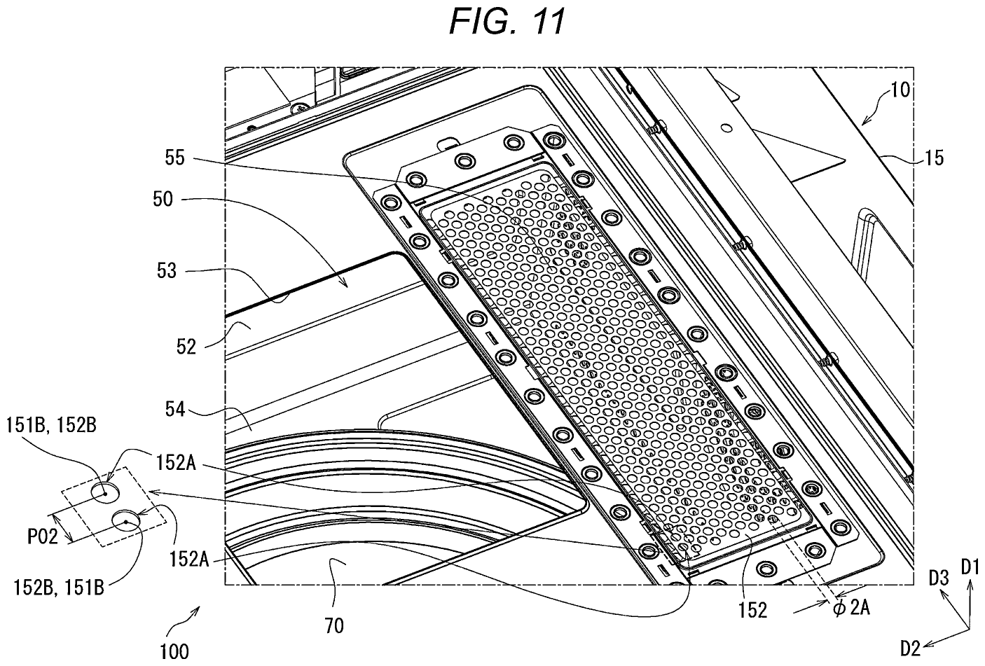

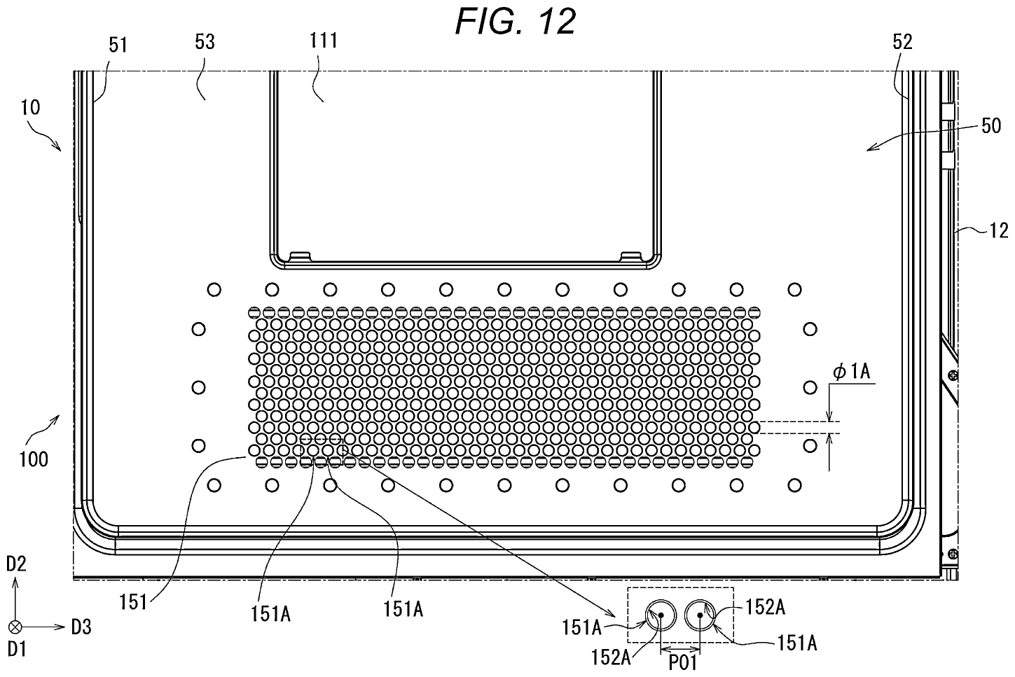

Hereinafter, the shielding/transmitting portion 150 will be described with reference to FIGS. 10 to 12. FIG. 10 is an enlarged view of a cross section of the first heater 121 and the shielding/transmitting portion 150 illustrated in FIG. 5. FIG. 11 is a perspective view of the shielding/transmitting portion 150 illustrated in FIG. 10 when viewed diagonally from the upper right front. FIG. 12 is a view of the shielding/transmitting portion 150 illustrated in FIG. 10 when viewed from below. As illustrated in FIGS. 10 to 12, the shielding/transmitting portion 150 includes at least a first plate-shaped member 151 and a second plate-shaped member 152. That is, the heating cooker 100 includes the first plate-shaped member 151 and the second plate-shaped member 152.

The first plate-shaped member 151 and the second plate-shaped member 152 are, for example, punching metal, and are manufactured by performing punching on a metal plate. Hence, the first plate-shaped member 151 and the second plate-shaped member 152 have a plurality of through-holes 151A and a plurality of through-holes 152A, respectively. In FIGS. 10 to 12, for convenience of illustration, reference numerals “151A” and “152A” are attached to two through-holes in each of the first plate-shaped member 151 and the second plate-shaped member 152.

Each of the first plate-shaped member 151 and the second plate-shaped member 152 is positioned between the first heater unit 120 and the heating cooking compartment 50, and expands in the second direction D2 and the third direction D3 at each position thereof. The first plate-shaped member 151 expands substantially parallel to the glass plate 125 at a position apart from the glass plate 125 in a downward direction. The second plate-shaped member 152 is positioned below the first heater 121 and the glass plate 125, and is positioned above the first plate-shaped member 151. According to the embodiment, it is possible to provide the heating cooker 100 having shielding performance and transmitting performance. To be specific, the first plate-shaped member 151 and the second plate-shaped member 152 are positioned at an interval G11 from each other. Hence, during microwave heating, leakage of microwaves from the inside to the outside of the heating cooking compartment 50 is reduced. In addition, since the first plate-shaped member 151 and the second plate-shaped member 152 have the plurality of through-holes 151A and 152A, respectively, infrared rays from the first heater unit 120 are radiated to the heating cooking compartment 50 during the infrared heating. That is, according to the embodiment, it is possible to provide the heating cooker 100 having the shielding performance and the transmitting performance.

The second plate-shaped member 152 is preferably positioned along the glass plate 125. The second plate-shaped member 152 may be in direct contact with the glass plate 125 or may be separated from the glass plate 125. Since the glass plate 125 is provided to close the through-holes 152A of the second plate-shaped member 152, moisture and salt can be prevented from moving from the heating cooking compartment 50 to the first tube 123. Accordingly, a devitrification phenomenon of the first tube 123 can be prevented. Specifically, the glass plate 125 is fixed to be sandwiched between the second plate-shaped member 152 and a glass plate holder formed on the heat reflection plate 124. According to the embodiment, since the glass plate 125 is fixed without using an adhesive, there is no need to consider a heat resisting temperature of the adhesive, and the temperature of the first heater 121 can be further increased. As a result, a time for heating and cooking the heating-target object can be shortened.

The through-holes 151A of the first plate-shaped member 151 overlap the through-holes 152A of the second plate-shaped member 152, respectively. To be specific, in the embodiment, the through-holes 151A overlap the through-holes 152A in the first direction D1. According to the embodiment, infrared rays from the first heater unit 120 can be more easily radiated to the heating cooking compartment 50 than in a case where the through-holes 151A and the through-holes 152A do not overlap each other. A direction of one with respect to the other of the through-holes 151A and 152A is not limited to the first direction D1, and depends on a direction of the first heater unit 120 to the heating cooking compartment 50. That is, the through-hole 151A may overlap the through-hole 152A in a direction other than the first direction D1.

It is preferable that a central axis 151B of the through-hole 151A and a central axis 152B of the through-hole 152A be positioned collinearly. With this configuration, infrared rays from the first heater unit 120 can be more easily radiated to the heating cooking compartment 50 than in a case where central axes 151B and 152B are not collinear.

In order to reduce uneven heating during infrared heating and improve heating efficiency, it is preferable that a pitch P01 of the through-holes 151A and a pitch P02 of the through-holes 152A be the same as each other. The pitch P01 of the through-holes 151A is a center-to-center distance between two adjacent through-holes 151A. The pitch P02 of the through-holes 152A is a center-to-center distance between two adjacent through-holes 152A.

A diameter φ2A of the through-hole 152A is smaller than a diameter φ1A of the through-hole 151A. With this configuration, leakage of microwaves from the through-holes 152A is decreased as compared with a case where the diameter φ2A is not smaller than the diameter φ1A. Note that the diameters φ1A and φ2A are much shorter than the wavelength (about 12 cm) of the microwave. Usually, the diameters φ1A and φ2A are preferably smaller than 4 mm, but according to the embodiment, leakage of microwaves can be satisfactorily reduced even if the diameters φ1A and φ2A are slightly increased. For example, the diameter φ1A can be 6 mm, and the diameter φ2A can be 5.2 mm. As a result, not only a carbon heater susceptible to microwaves can be used, but also infrared rays emitted from the carbon heater can be further transmitted.

Next, a modification of the first heater unit 120 will be described with reference to FIG. 10.

As illustrated in FIG. 10, the first heater unit 120 preferably includes a metal film 127 on an outer circumferential surface of the first tube 123. The metal film 127 is formed, for example, by evaporating a specific metal and depositing the metal on a surface of the first tube 123. A typical example of the specific metal is gold (Au).

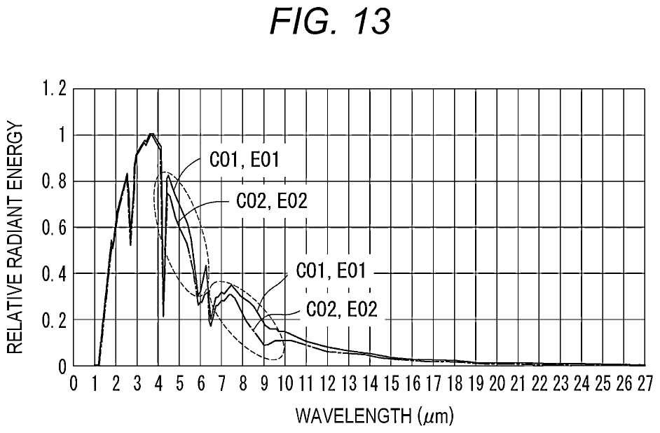

The inventors of the present application acquired wavelength characteristics of the carbon heater with the metal film 127 and the carbon heater without the metal film 127. FIG. 13 is a graph illustrating wavelength characteristic curves thereof. In FIG. 13, the horizontal axis represents wavelength, and the vertical axis represents relative radiant energy. The relative radiant energy is obtained by dividing radiant energy for each wavelength by the maximum radiant energy.

FIG. 13 further illustrates curves C01 and C02. The curve C01 is a wavelength characteristic curve of relative radiant energy E01 of the carbon heater with the metal film 127. The curve C02 is a wavelength characteristic curve of relative radiant energy E02 of the carbon heater without the metal film 127.

According to FIG. 13, the relative radiant energy E01 is higher than the relative radiant energy E02 in most of a wavelength range of about 4.5 μm or longer and about 10 μm or shorter (the wavelength range surrounded by a broken line). To be specific, the relative radiant energy E01 is higher than the relative radiant energy E02 within a range of about 1.2 times or more and about 2.0 times or less. Hence, since the first heater unit 120 includes the metal film 127, the far-infrared radiation effect is improved. That is, a surface of the heating-target object can be heated in a short time.

The embodiment of the present disclosure has been described above with reference to the drawings. However, the present disclosure is not limited to the above embodiment, and can be implemented in various aspects without departing from the gist thereof. For easy understanding, the drawings schematically illustrate the individual components mainly, and the thicknesses, lengths, number, and the like of the individual components illustrated in the drawings are different from actual ones for convenience of preparation of the drawings. In addition, the materials, shapes, dimensions, and the like of the individual components illustrated in the above embodiment are merely examples, and are not particularly limited, and various modifications can be made without substantially departing from the effects of the present disclosure.

(1) In the embodiment, the shielding/transmitting portion 150 is disposed between the first heater unit 120 and the heating cooking compartment 50. However, the present disclosure is not limited to this, and the shielding/transmitting portion 150 may also be disposed between at least one of the second heater unit 130 and the third heater 142 and the heating cooking compartment 50. In this case, at least one of the second heater unit 130 and the third heater 142 is another example of the “first heater unit” of the present disclosure.

The present disclosure provides a heating cooker, and has industrial applicability.

What is claimed is:

1. A heating cooker comprising:
a heating compartment;
an infrared heater configured to emit infrared rays directed from an outside to an inside of the heating compartment;
a microwave generator configured to emit microwaves directed from the outside to the inside of the heating compartment;
a first plate-shaped member positioned between the infrared heater and the heating compartment and have a plurality of through-holes; and
a second plate-shaped member positioned apart from the first plate-shaped member between the first plate-shaped member and the infrared heater and have a plurality of through-holes.

2. The heating cooker according to claim 1, wherein the through-holes of the first plate-shaped member overlap the through-holes of the second plate-shaped member.

3. The heating cooker according to claim 1, wherein a central axis of each of the through-holes of the first plate-shaped member and a central axis of each of the through-holes of the second plate-shaped member are positioned collinearly.

4. The heating cooker according to claim 1, wherein a diameter of each of the through-holes of the second plate-shaped member is smaller than a diameter of each of the through-holes of the first plate-shaped member.

5. The heating cooker according to claim 1, wherein the infrared heater is a carbon heater.
